(19) United States
(12) Patent Application Publication
(10) Pub. No.: US 2020/0109359 A1
(43) Pub. Date: Apr. 9, 2020

(54) YEAST FOR BEER PRODUCTION

(71) Applicant: Chr. Hansen A/S, Hoersholm (DK)

(72) Inventors: Sofie SAERENS, Hoersholm (DK); Philipp Paul GRUENERT, Nienburg (DE); Mikkel Gulmann MADSEN, Hoersholm (DK); Katja Sander JENSEN, Hoersholm (DK)

(73) Assignee: Chr. Hansen A/S, Hoersholm (DK)

(21) Appl. No.: 16/370,750

(22) Filed: Mar. 29, 2019

(30) Foreign Application Priority Data
Oct. 4, 2018 (EP) 18198654.8

(51) Int. Cl. C12C 12/00; C12C 11/09

(52) U.S. Cl. CPC C12C 12/006; C12C 2200/31; C12C 11/09

(57) ABSTRACT

The present invention relates to a new yeast product that is suitable for the production of beer, and uses of this product. The product is a closed container containing 0.1 to 50 l of a frozen yeast product wherein the frozen yeast product contains at least one strain, e.g. one, two or three yeast strains, suitable for beer brewing in a total concentration of at least 10⁹ CFU/g, with each yeast strain suitable for beer brewing being present in a concentration of at least 10⁸ CFU/g, the frozen yeast product provides a liquid aqueous suspension with a dry matter content below 35% (w/w) upon thawing; and no cryoprotectant is added to the frozen yeast product.

### TECHNICAL FIELD

The present invention relates to a new yeast product that is suitable for the production of beer, and uses of this product.

### BACKGROUND ART

The brewer aims to produce a beer that will satisfy the consumer. This is achieved by providing a beer that complies with its specification (content, taste and appearance). It is known that bacterial contaminants can spoil beer production. It is therefore mandatory for the brewer to comply with the beer specification, to ensure that the equipment is as free from unwanted organisms as possible by applying hygiene practices and to control the quality of the brewing yeast throughout the brewing process. The aim is to start fermentation with a yeast culture that is not stressed, is highly vital and viable, is adapted to the metabolism of wort sugars and other nutrients, and is free of contaminating microorganisms such as bacteria. Such a starter culture can be prepared from a stock culture by propagation. Alternatively, rehydrated and activated dried yeast may be used (see e.g. G.G. Stewart, Brewer's Yeast Propagation: The Basic Principles; MBAA TQ, Vol. 54, No. 3, 2017, pp. 125-131). Both propagation and the use of dried yeast however still entail the risk of contamination and changes in the integrity of the yeast culture. Such propagated or dried yeast is added in relatively small volume, typically less than 1 L per 100 L wort, to the fermentation tank.

WO2011/134952 describes the production of a yeast starter culture by fermenting yeast, followed by harvesting the yeast by centrifugation. To protect the cells from the harsh freezing conditions, a cryoprotectant is added, typically in an amount of about 5 to 25%, to maintain the number of CFU at approximately 10⁹ or above.

There is however an increasing demand from consumers for so-called “clean label” food products, where the number of additives added to the products is limited. Furthermore, the use of additives dilutes the concentrate resulting in a lower number of yeast cells in the final yeast formulation. To meet this demand, WO2016/193465 provides a compressed yeast product with a dry matter content between 35 and 90%.

In view of the state of the art, the present invention addresses the problem of providing a “clean label” product in volumes typically used in the brewing industry or even lower volumes that can be used directly for inoculating wort (pitching), while minimizing the risk of microbial contamination.

### SUMMARY OF THE INVENTION

The present invention provides a closed container containing 0.1 to 50 L of a frozen yeast product wherein

the frozen yeast product contains at least one strain, e.g. one, two or three yeast strains, suitable for beer brewing in a total concentration of at least 10⁹ CFU/g, with each yeast strain suitable for beer brewing being present in a concentration of at least 10⁸ CFU/g, the frozen yeast product provides a liquid aqueous suspension with a dry matter content below 35% (w/w) upon thawing; and

no cryoprotectant is added to the frozen yeast product.

The present invention also provides a method for producing a frozen yeast product, comprising the steps of
a. growing yeast in a nutrient medium to a concentration of at least 10⁸ CFU/g,
b. concentrating the yeast to a concentration of at least 5×10⁸ CFU/g to provide a liquid aqueous suspension with a dry matter content below 35% (w/w),
c. filling the liquid aqueous suspension in a container, and
d. freezing the liquid aqueous suspension.

The product of the present invention can be used in the production of beer. A preferred method for producing beer comprises the steps of
a. providing at least 50 L of wort in a fermentation tank;
b. connecting, e.g. by means of a pipe or tube, the closed container according to the present invention with the tank so that the yeast product can be transferred (e.g. by pumping or injecting) to the fermentation tank; and
c. fermenting the wort to provide beer.

### FIGURES

FIG. 1. Vitality of the S. pastorianus FYP and ADY products. Vitality is given in % of cells with high vitality in total cells

FIG. 2. Fermentation performance of S. pastorianus FYP Thawed Direct, S. pastorianus ADY Rehydrated and S. pastorianus ADY Direct in degrees Plato in dry hopped light malt extract of 12° P in a pitching rate of 1*10\hat{ }7 CFU/mL

FIG. 3. Fermentation performance of S. pastorianus FYP Thawed Direct, S. pastorianus ADY Rehydrated and S. pastorianus ADY Direct in degrees Plato in dry hopped light malt extract of 18° P in a pitching rate of 1*10\hat{ }7 CFU/mL

FIG. 4. Fermentation performance of S. pastorianus FYP and S. pastorianus ADY in degrees Plato in dry hopped light malt extract of 11° P in a pitching rate of 1*10\hat{ }6 CFU/mL

FIG. 5. Fermentation performance of S. pastorianus FYP and S. pastorianus ADY in degrees Plato in medium malt extract of 11° P in a pitching rate of 1*10\hat{ }6 CFU/mL

FIG. 6. Fermentation performance of S. pastorianus FYP and S. pastorianus ADY in pH decrease in dry hopped light malt extract of 11° P in a pitching rate of 1*10\hat{ }6 CFU/mL

FIG. 7. Fermentation performance of S. pastorianus FYP and S. pastorianus ADY in pH decrease in medium malt extract of 11° P in a pitching rate of 1*10\hat{ }6 CFU/mL

### DETAILED DESCRIPTION

The present invention provides a yeast product for the brewing industry.

Yeasts to be Used in the Present Invention

According to the present invention, any yeast known to be suitable for brewing beer may be used. Such yeasts include top-fermenting yeasts and bottom-fermenting yeasts. Top-fermenting yeasts are used for the production of ales, porters, stouts, Altbier, Kösch, and wheat beers. and are typically those of the species Saccharomyces cerevisiae. Bottom-fermenting yeasts such are used for the production of lagers such as Pilsners. Dortmunders, Märzen, Books, and American malt liquors and are typically those of the species Saccharomyces pastorianus. In some embodiments, the yeast product of the present invention contains at least one strain selected from among the species Saccharomycodes ludwigii, Scheffersomyces shehatae, Wickerhamomyces anomalus, Pichia kluyveri and Zygosaccharomyces rouxii. These yeasts are used for the production of low-alcohol and non-alcoholic beers either as the only yeast species added or in addition to a top-fermenting yeasts such as Saccharomyces cerevisiae or a bottom-fermenting yeast such as Saccharomyces pastorianus. The product of the present invention additionally or alternatively may contain a yeast that is desirable to afford a different aromatic profile, such as a yeast from the genera Candida, Hanseniaspora, Brettanomyces, Issatchenkia, Kazachstania, Lachancea (e.g. Lachancea thermotolerans), Pichia, Kluyveromyces, Schizosaccharomyces, Torulaspora (e.g. Torulaspora delbrueckii), Wickerhamomyces, Williopsis and Zygosaccharomyces.

In one embodiment, the yeast present in the product of the present invention consists of at least one strain, e.g. one, two or three yeast strains, of Saccharomyces pastorianus or Saccharomyces cerevisiae. In another embodiment of the present invention, the product of the present invention consists of at least one strain, e.g. one, two or three yeast strains, selected from the species Saccharomycodes ludwigii, Scheffersomyces shehatae, Wickerhamomyces anomalus, Pichia kluyveri or Zygosaccharomyces rouxii. In yet another embodiment, the yeast present in the product of the present invention consists of one or two strains of Saccharomyces pastorianus or Saccharomyces cerevisiae and one or two strains selected from the species Saccharomycodes ludwigii, Scheffersomyces shehatae, Wickerhamomyces anomalus, Pichia kluyveri and Zygosaccharomyces rouxii. In a further embodiment, the yeast present in the product of the present invention consists of one or two strains of Saccharomyces pastorianus or Saccharomyces cerevisiae and one or two strains from Candida, Hanseniaspora, Brettanomyces, Issatchenkia, Kazachstania, Lachanacea, Pichia, Schizosaccharomyces, Torulaspora (e.g. Torulaspora delbrueckii), Wickerhamomyces, Williopsis or Zygosaccharomyces. In this embodiment, one strain selected from the species Saccharomycodes ludwigii, Scheffersomyces shehatae, Wickerhamomyces anomalus, Pichia kluyveri and Zygosaccharomyces rouxii may be additionally present.

Any undesired microorganisms, i.e. bacterial contaminants, are preferably present in the frozen yeast product in a total amount of less than 20 CFU/g, more preferably in a total amount of less than 10 CFU/g.

Production of the Yeast Product of the Present Invention

For the production of the yeast product of the present invention, the yeast strain or strains are taken from stock yeast cultures and are then grown in a nutrient medium to a concentration of at least 10⁸ CFU/g, preferably at least 5 times 10⁸ CFU/g, more preferably at least 10⁹ CFU/g. The yeast concentration will generally remain below 10¹⁰ CFU/g at the end of this growth step. This growth step is generally performed under aerobic conditions: Oxygen has to be supplied in a sufficient amount to prevent the yeast to go into the fermentative state, resulting in respiratory metabolism with high biomass formation and low or no ethanol production. As nutrient medium any medium supplying a sufficient amount of sugars, nitrogen, vitamins, minerals such as copper, magnesium, potassium and zinc, and nucleic acids may be used. A fatty acid, preferably a C16 to C20 acid such as oleic acid, or a salt thereof, may be added. In one embodiment wort such as all-malt wort can be used as nutrient medium. Standard or high gravity wort may be used, preferably wort with a gravity of 12 to 25° Plato, more preferably 12 to 25° Plato, even more preferably 16 to 25 ° Plato.

Wort—used both for the production of the yeast product and for beer production, as described below—can be produced from one or more types of grains such as grains found within the true cereal grains from the botanical family ‘Poaceae’ including wheat, oat, rice, corn (maize), barley, sorghum, rye, and millet, and varieties thereof such as farro, freekeh, emmer and spelt which are all types of wheat, as well as new grains like triticale which is a mixture of wheat and rye; and grains found within the ‘pseudo-cereal’ group which is not part of the Poaceae botanical family, including amaranth, buckwheat, and quinoa; and grains with seeds from a number of different plant species external to the Poaceae family, which however are nutritionally similar and used in ways similar to ‘true’ grains.

At the end of the growth step, or subsequent to the growth step, a step of increasing the cellular trehalose content is preferably performed. For example, the yeast may be deprived of oxygen and a carbon source to induce the accumulation of cellular trehalose. This step may be performed when the cell concentration is at least 10⁸ CFU/g.

After the growth and the optional step of increasing the cellular trehalose content, the cellular trehalose content is preferably 15 to 28 wt. % with respect to the yeast dry weight, more preferably 18 to 25 wt. %, even more preferably 20 to 23 wt. %.

The yeast cell suspension as obtained after the growth and the optional step of increasing the cellular trehalose content is then concentrated to a concentration of at least 5×10⁹ CFU/g to provide a liquid aqueous suspension with a dry matter content below 35% (w/w). In this step, the cell concentration is generally concentrated 5 to 15 times, typically 8 to 10 times. Different methods for concentrating yeast cell suspensions are known to the skilled person. Preferred is the concentration by centrifugation. The concentration step has to be performed such that the liquid aqueous suspension obtained thereby has a dry matter content below 35% (w/w), preferably a dry matter content of less than 30% (w/w), such as 18 to 25% (w/w), for example 20 to 24% (w/w). The liquid aqueous suspension with such dry matter content is pumpable or injectable so that it can be transferred to a fermentation flask by injection or pumping. Particularly preferred is the liquid suspension obtained by the concentrating step has a cell concentration of 2×10⁹ to 8×10⁹ CFU/g (such as 2×10⁹ to 4×10⁹ CFU/g) and a dry matter content of 20 to 25% (w/w).

The dry matter content is determined m_{dry}/m_{liq}, where m_{liq} is the mass of the liquid suspension and m_{dry} is the mass obtained after complete removal of all water from the liquid suspension.

According to the present invention, the concentrated yeast cell suspension is generally filled into the container without further change of its composition. Besides the nutrients present in the nutrition medium, no other chemicals such as cryoprotectants e.g. glycerol, DMSO, ethylene glycol, or propylene glycol are generally added to the yeast cell suspension after the growth and concentration steps. Sugar-based cryoprotectants are not added to the yeast cell suspension after the growth and concentration steps either. However, sugars are generally present in the nutrient medium, and sugars may also be formed by the yeast cells during the cultivation, for example, the liquid yeast suspension preferably contains 15 to 28 wt. % with respect to the yeast dry weight, more preferably 18 to 25 wt. %, even more preferably 20 to 23 wt. % of trehalose, and possibly other sugars. The yeast cell suspension may also contain a fatty acid, preferably a C16 to C20 acid such as oleic acid, or a salt thereof. However, the yeast cell suspension is free of non-sugar-based cryoprotectants. In other words, the liquid yeast suspension obtained by the concentrating step preferably consists of the yeast cells, nutrient medium such as wort, any possible degradation products and metabolites thereof formed in the method, water, and possibly unavoidable contaminants. This preferred suspension has a yeast cell concentration of 2×10⁹ to 8×10⁹ CFU/g (such as 2×10⁹ to 4×10⁹ CFU/g) and a dry matter content of 20 to 25% (w/w).

The liquid aqueous suspension obtained by the concentrating step is then transferred into a container. This step is preferably performed under essentially sterile conditions to avoid any contamination of the product. The container is also preferably sterile. The container has a volume of 0.05 to 50 L, preferably 0.3 to 30 L, more preferably 1 to 20 L. The container is thus easily manageable and transportable. The container is closable so that it can be transported without the risk of microbial contamination.

In one embodiment, the container is a plastic bag. For example, the liquid aqueous suspension obtained by the concentrating step can be filled into the plastic bag by means of a needle penetrating the plastic. Upon withdrawal of the needle, the plastic bag is again closed (i.e. the bag is self-sealing). In an alternative embodiment, the container is a plastic or glass bottle filled in a sterile way and where a cap is connected to a hose when inoculating.

If the frozen yeast product of the present invention contains more than one yeast strain suitable for brewing, different liquid aqueous suspensions, each obtained as described above and each containing a different yeast strain, may be filled into the container. In this case, each yeast strain suitable for beer brewing is present in a concentration of at least 10⁸ CFU/g in the frozen yeast product of the present invention.

To provide the frozen yeast product of the present invention, the liquid suspension provided in the closed container is subjected to a freezing step. The container is preferably frozen down to −20 to −60° C., preferably to −40° C. to −50° C., and stored at this temperature. The freezing process is preferably done slowly taking a couple of hours, such as 2 to 5 hours, depending on the volume of the container.

The Yeast Product of the Present Invention

As a result of this method, a closed container containing 0.05 to 50 L of a frozen yeast product, wherein

the frozen yeast product contains at least one strain, e.g. one, two or three yeast strains, suitable for beer brewing in a total concentration of at least 10⁹ CFU/g, with each yeast strain suitable for beer brewing being present in a concentration of at least 10⁸ CFU/g, the frozen yeast product provides a liquid aqueous suspension with a dry matter content below 35% (w/w) upon thawing; and

no cryoprotectant is added to the frozen yeast product,

is obtained.

This product can be stored and/or shipped in a frozen state, such as storage and/or shipment prior to use for brewing. When the product is to be used for brewing it may simply be thawed, preferably by keeping it at 20 to 30° C., optionally in a water bath, until the entire product is in a liquid state, and then the liquid yeast product can be transferred to the fermentation tank, preferably in a closed tube system to avoid any contamination.

This thawed product has a dry matter content below 35% (w/w), preferably a dry matter content of less than 30% (w/w), such as 18 to 25% (w/w). The liquid aqueous suspension with such dry matter content is pumpable or injectable so that it can be transferred to a fermentation flask by injection or pumping. The thawed yeast product contains at least one yeast strain, e.g. one, two or three yeast strains, suitable for beer brewing in a total concentration of at least 10⁹ CFU/g, with each yeast strain suitable for beer brewing being present in a concentration of at least 10⁸ CFU/g. In a presently preferred embodiment, the liquid suspension obtained after thawing contains one, two or three yeast strains suitable for beer brewing in a total concentration of 1×10⁹ to 8×10⁹ CFU/g and a dry matter content of 20 to 25% (w/w).

The product is further preferably characterized by a high vitality. According to the present invention, the yeast cells in the thawed product show a vitality of at least 80%, preferably at least 85%, more preferably at least 90%, such as 92 to 96% (number of vital cells with respect to total number of cells).

According to the present invention, yeast vitality is determined on a yeast NucleoCounter/Luna Ilyf™ Automated Yeast Cell Counter with the method described in the user manual (Version 2016: LBSM-MD-ML-LUY-001 VL1609-01) Ref online:

http://wisbiomed.com/dnId/LUNA-II%20YF-User-Manual.pdf). A yeast suspension is prepared according to standard procedures (making sure that the yeast suspension is within the correct measurement range) and mixed gently but thoroughly to ensure that the suspension is homogenous. For yeast samples that are highly dense, the sample may be diluted by at least 1:100 with Cell Dilution Buffer II prior to counting. 18 μL yeast suspension is mixed with 2 μL Acridine Orange/Propidium Iodide Stain. Pipette gently and incubate the sample for 10 minutes at room temperature and then prepare a new PhotonSlide™ or a clean LUNA™ Reusable Slide. Hold the slide by its edges and load 10-12 μL of the cell sample into a sample chamber and read the slide with the LUNA II YF™. Acridine orange stain is a cell-permeant vital dye that binds to nucleic acids. Acridine Orange Stain can be used with Propidium Iodide Stain to assess cell viability with the LUNA II YF™. Viable nucleated cells will fluoresce green and nonviable nucleated cells will fluoresce red.

It was surprising to find that the frozen product, upon thawing, shows such a high viability and vitality since it is well-known that processing yeast affects both its viability and its vitality. For example, the average viability of dried yeast is 20 to 30% lower than that of freshly propagated yeast. Moreover, without rehydration and activation, the vitality of dried yeast is extremely low (see Example 1). Similarly, freezing is a known stress condition. To improve the survival rate of frozen yeast cells, the cells are therefore usually (i.e. in the prior art) frozen in a solution containing a cryoprotectant such as glycerol. To obtain a yeast product fit for fermentation, such stock cultures need to be revitalized and then propagated (see e.g. G. G. Stewart, Brewer's Yeast Propagation: The Basic Principles; MBAA TQ, Vol. 54, No. 3, 2017, pp. 125-131).

The thawed product, provided in the closed container, is moreover characterized in that it preferably contains bacterial contaminants in a total amount of less than 20 CFU/g, more preferably less than 10 CFU/g.

In a particularly preferred embodiment, the product of the present invention is a closed plastic bag containing 0.05 to 50 L of a frozen yeast product, wherein the frozen yeast product contains at least one strain, e.g. one, two or three yeast strains, suitable for beer brewing in a total concentration of at least 10⁹ CFU/g, with each yeast strain suitable for beer brewing being present in a concentration of at least 10⁸ CFU/g, the frozen yeast product provides a liquid aqueous suspension consisting of the yeast cells, nutrient medium such as wort, any possible degradation products and metabolites thereof formed in the method, water, and possibly unavoidable contaminants, with a dry matter content a dry matter content of 20 to 25% (w/w) upon thawing; and wherein the yeast cells have a vitality of at least 90% upon thawing.

Uses of the Yeast Product of the Present Invention

The frozen yeast product according to the present invention, upon thawing, provides a number of advantages for brewing. Firstly, thanks to sufficiently high concentration of viable cells, it can be used directly for fermentation (i.e. for direct inoculation), without the need of any intermediate steps. The contents simply have to be transferred into the fermentation tank, preferably through a sterile pipe or tube. For example, in embodiments where the container is a plastic bag, a needle can be injected into the plastic bag for transferring the contents into the fermentation tank, preferably through a sterile pipe or tube. Generally, 1 L or less of the thawed frozen yeast product per 100 L (1 hL) fermentation medium (wort) is sufficient for inoculation. Hence, a relatively small volume of yeast product can be added to the fermentation tank, which is important for brewing, particularly because the composition of the fermentation medium (wort) essentially stays constant after addition. Preferably, 0.03 to 0.8 L, more preferably 0.1 to 0.5 L of the thawed frozen yeast product is used for inoculating 100 L wort. Thus, established volumes of yeast product can be used for pitching, or even smaller volumes. (According to Ullmann's Encyclopedia of Industrial Chemistry, 0.5 to 0.7 L are added to 1 hL for pitching.)

Thus, in contrast to active dried yeast, the closed container containing the frozen yeast product of the present invention provides the advantage in the context of brewing that it can be transferred, e.g. by pumping or injecting, to the fermentation tank in a closed system and without further manipulation, except for thawing, thereby reducing the risk of further contamination. Moreover, compared to active dried yeast, the use of the product of the present invention can provide a faster fermentation and thus a shorter fermentation time.

The present invention thus also provides a method for producing beer, comprising the steps of
a. providing at least 50 L of wort in a fermentation tank;
b. connecting, e.g. by means of a pipe or tube, the closed container according the present invention with the tank so that the yeast product can be transferred (e.g. by pumping or injecting) to the fermentation tank; and
c. fermenting the wort to provide beer.

As discussed above, the preferred volume of the yeast product provided in the container depends on the volume of wort in the fermentation tank. The fermentation and subsequent processing (e.g. filtration) is performed in the usual manner.

The wort has a preferred gravity (a measure of sugar content) of at least 10° Plato, preferably at least 12° Plato, more preferably at least 16° Plato. at least 12° Plato, such as 16 to 25 ° Plato. It was surprisingly found that the advantages of the products of the present invention with regard to fermentation time are particularly pronounced when fermenting high gravity wort.

In one embodiment, the yeast product can be used to start fermentation without prior propagation. This is what is usually performed at smaller breweries like craft breweries and microbreweries. In this way, the yeast product can be directly inoculated into the fermentation tank. The fermentation tank has a preferred size of 50 L up to 100 000 L, such as 100 to 10 000 L.

In another embodiment, the yeast product can be used to shorten the yeast propagation time and as such, can be inoculated at any step during the yeast propagation. Yeast propagation often starts in a Carlsberg flask, which contains between 10-30 L of wort. Normal yeast propagation will propagate the yeast in a certain volume and this volume will be used to inoculate 10 times the propagation volume.

In a further embodiment, the yeast product can be used to avoid repitching. Traditionally, the yeast slurry obtained after fermentation is re-used. Such a repitching is usually repeated 3 to 10 times. Instead of re-using the yeast slurry for fermentation, the product of the present invention can be used. This is particularly advantageous in the case of brewing using more than 1 brewing yeast strain as the ratio of strains can be kept essentially stable over various fermentation batches.

### EXAMPLES

Introduction

In the examples, a comparison is made between the frozen yeast product according to the present invention (FYP) and active dried yeast (ADY) of a known lager-type beer strain: Saccharomyces pastorianus W34/70. FYP was prepared as described above. Two different formats of ADY are used, as is common practice in the brewing industry: ADY rehydrated and ADY direct inoculation.

In Example 1, both yeast products are compared with respect to dry matter content, viability and vitality, as well as the amount and types of contaminants.

In Example 2, the FYP and ADY yeast are compared in fermentation performance in two different wort types: 1) wort with a gravity content of 12° Plato and 2) wort with a gravity content of 18° Plato (called high gravity brewing).

In Example 3, the FYP and ADY yeast are compared in a lower pitching rate in fermentation performance in two different wort types: 1) dry hopped light malt extract with a gravity content of 11° Plato and 2) medium malt extract with a gravity content of 10° Plato (called high gravity brewing).

### Example 1

### Product Characterization: Vitality; Dry Matter, Contaminants

Dry Matter Content

Dry matter content was measured with a Sartorius MA 35 Moisture Analyzer according to the user manual, version 98648-013-57. Ref online: https://m.laboratory-equipment.com/uploads/tech_resources/manma35e_103014194241.pdf.

Dry matter was measured according to the following procedure:
place a disposable aluminum sample pan (provided by Sartorius) with a filter paper (provided by Sartorius) in the dry matter balance
distribute the amount of sample evenly on the filter and close the lid gently to avoid disturbance of the weighing.
The sample size should be 4.8 to 5.2 gram for each measurement
Temperature for the measurement is 110° C.
Measuring time is until a constant weight is reached
Result is described in % dry matter

Results are shown in the following table.

| | Dry matter content |
|---|---|
| S. pastorianus | 94.71% |
| ADY | |
| S. pastorianus | 21.91% |
| FYP | |

Hence, the S. pastorianus ADY had a dry matter content of 94.71% and S. pastorianus FYP of the present invention was found to have a dry matter content of 21.91%.

Yeast Product Viability and Vitality

The FYP was found to have a viability of 2.72×10⁹ CFU/g, whereas the ADY had a viability of 6×10⁹ CFU/g.

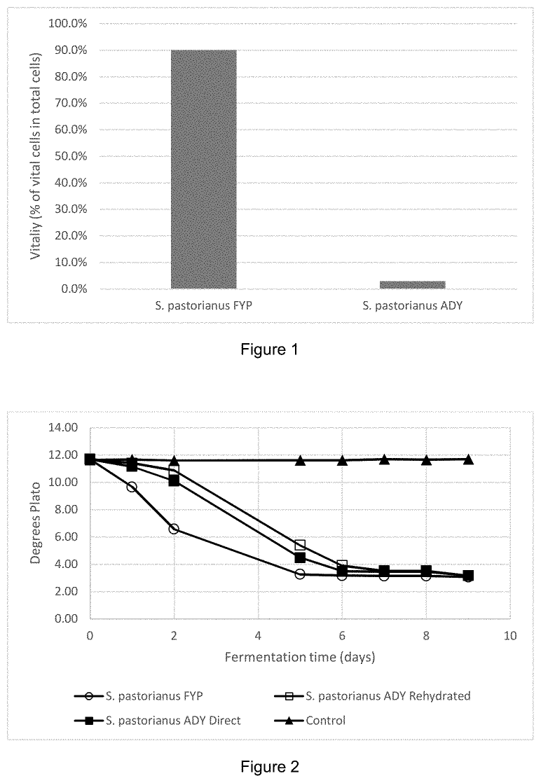

Moreover, both the S. pastorianus FYP and ADY products were tested for vitality on a yeast NucleoCounter, which can measure the total cell count and vitality of yeast cells. This was done on a Luna II yf™ Automated Yeast Cell Counter with the method as described in the user manual and outlined above. The results are depicted in FIG. 1.

FIG. 1 clearly shows that the vitality of the S. pastorianus FYP product is much higher (90% viability) compared to the S. pastorianus ADY product (2.8% viability).

Microbial Contaminant Analysis

Bacterial contamination in both the S. pastorianus ADY and FYP was analyzed by plating both yeast products on different solid media, which are specific to a certain group of bacterial microorganisms. Both yeast products were tested for lactic acid bacteria and non-lactic acid bacteria. To define further which non-lactic acid bacteria were present, specific media were used to detect Staphylococci, Enterococci and Bacillus.

The bacterial count in the FYP was tested by taking 1 ml of the FYP plating this 1 ml on the described media. The bacterial count in the ADY was tested by dissolving 10 g of ADY in 90 ml peptone water and plating 1 ml of this solution on the described media.

Media and Culturing Conditions Used for the Different Bacterial Counts:

Non-lactic acid bacteria: The method is a colony count method using a Sugar Free Agar (spread plate) that is incubated at 30° C. for 48 h or 72 h. Non-lactic acid bacteria can—contrary to lactic acid bacteria—grow on this sugar free medium because they are able to use protein as a carbohydrate source.

Staphylococci: The method is a colony count method using Baird Parker agar (spread plate) that is incubated at 37° C. for 48 h.

Enterococci: The method is a colony count method using COMPASS Enterococcus agar (spread plate) that is incubated at 44° for 48 h.

Bacillus: The method is a colony count method using Blood Agar (spread plate) incubated at 30° C. for 48 h.

Lactic acid bacteria: The method is a colony count method using MRS agar at pH 5.4 incubated at 37° C. for 72 hours under anaerobic conditions.

Both the S. pastorianus ADY and FYP were tested first for lactic acid bacteria and non-lactic acid bacteria: (see table below).

### Bacterial Count in S. Pastorianus FYP and ADY

| | ADY | FYP |
|---|---|---|
| Lactic acid bacteria (CFU/g) | <1 | <1 |
| Non-lactic acid bacteria | 20 | <10 |
| (CFU/g) | | |

The S. pastorianus ADY had a bacterial count of non-lactic acid bacteria of 20 CFU/g, while the S. pastorianus FYP had a non-lactic acid bacteria count of <10 CFU/g, which is the detection limit. Both yeast products did not contain lactic acid bacteria. To define further which non-lactic acid bacteria were present in the S. pastorianus ADY, specific media were used to detect Staphylococci, Enterococci and Bacillus species as described in materials and methods. After plating the S. pastorianus ADY on the different specific media, it was clear that the non-lactic acid bacteria detected were Bacillus species. The blood agar count was also 20 CFU/g for Bacillus.

### Example 2

### Fermentation Experiments

To investigate the effect of the S. pastorianus FYP and ADY products on fermentation performance, fermentations in two different gravities were carried out (wort with 12° P and 18° P). The S. pastorianus FYP and ADY fermentations were done as follows.

Fermentations with S. pastorianus FYP and ADY were done in dry hopped light malt extract. Dried barley malt extract from Muntons was used for the fermentation medium and was mixed with water to a concentration of 12° Plato or 18° Plato and then autoclaved at 121° C. for 15 minutes.

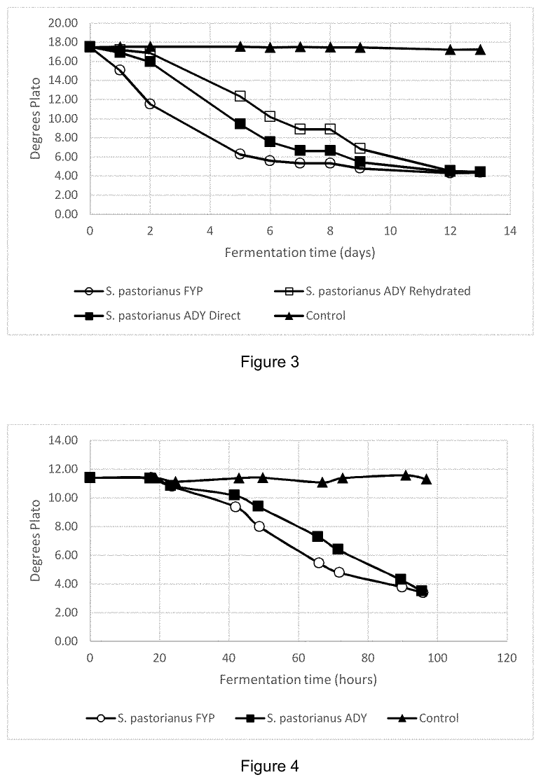

The FYP was inoculated directly after thawing. The ADY samples were inoculated in one of two ways, based on rehydration or direct inoculation: (1) following 30 minutes rehydration in peptone containing water or (2) directly pouring the ADY into the barley malt medium at ambient temperature (20° C.). All samples were inoculated at a level of approximately 1*10\hat{ }7 CFU/mL. The fermentation was done at 12° C., as is normally done with this lager-type S. pastorianus brewing yeast, in 400 mL barley malt medium in glass bottles with a total volume of 500 mL. The bottles were placed in an incubator at 12° C. The fermentations were followed using plating of the yeast on YGC plates and measuring degrees Plato (° P) with using an Anton Paar Densimeter DMA 35. Results are shown in FIG. 2 for 12° P and FIG. 3 for 18° P. The fermentation set-up is given in the following table 1.

TABLE 1
Fermentation set-up

| Sample | Medium | Concentration of medium | Volume | Temp (° C.) | CFU/g | Inoculation level | Inoculation Type |
|---|---|---|---|---|---|---|---|
| S. pastorianus FYP | Hopped light malt extract | 13 g/100 mL tap water | 400 mL | 12 | 2.72E+09 | 1.00E+07 | Thawed direct |
| S. pastorianus ADY | Hopped light malt extract | 13 g/100 mL tap water | 400 mL | 12 | 6.00E+09 | 1.00E+07 | Direct |
| S. pastorianus ADY | Hopped light malt extract | 13 g/100 mL tap water | 400 mL | 12 | 6.00E+09 | 1.00E+07 | Rehydrated |
| Control | Hopped light malt extract | 13 g/100 mL tap water | 400 mL | 12 | | | |
| S. pastorianus FYP | Hopped light malt extract | 21 g/100 mL tap water | 400 mL | 12 | 2.72E+09 | 1.00E+07 | Thawed direct |
| S. pastorianus ADY | Hopped light malt extract | 21 g/100 mL tap water | 400 mL | 12 | 6.00E+09 | 1.00E+07 | Direct |
| S. pastorianus ADY | Hopped light malt extract | 21 g/100 mL tap water | 400 mL | 12 | 6.00E+09 | 1.00E+07 | Rehydrated |
| Control | Hopped light malt extract | 21 g/100 mL tap water | 400 mL | 12 | | | |

Fermentations with S. pastorianus FYP and ADY were performed in dry hopped light malt extract as described in materials and methods. Two types of media were used for the fermentations: malt extract at 12° P and malt extract at 18° P. For each media type, 4 fermentations were carried out in duplicate: 1) S. pastorianus FYP, 2) S. pastorianus ADY rehydrated, 3) S. pastorianus ADY direct and 4) control.

As shown in FIG. 2, fermentation with S. pastorianus FYP was much faster compared to the S. pastorianus ADY Rehydrated and ADY Direct.). The fermentation with S. pastorianus FYP is done in 5 days compared 6 days for the S. pastorianus ADY Direct and 7 days for the S. pastorianus ADY Rehydrated.

The fermentation results of S. pastorianus FYP, S. pastorianus ADY Rehydrated and S. pastorianus ADY Direct in 18° P malt extract show that S. pastorianus FYP also was the best performer in these conditions. S. pastorianus FYP showed a much faster fermentation and the difference is more enhanced with the high sugar medium of 18° P vs 12° P, as shown in FIG. 3. S. pastorianus FYP shows a faster start of fermentation and the fermentation is done in 9 days, while the S. pastorianus ADY Rehydrated and ADY Direct show a very slow start of fermentation and need at least a day more to finish the fermentation, probably more.

### Example 3

### Fermentation Experiments in Different Media with Lower Dosage of Yeast

To investigate the effect of a lower pitching rate of the S. pastorianus FYP and ADY products and a different media type on fermentation performance, fermentations in two different wort types were carried out (dry hopped malt extract and medium malt extract). The S. pastorianus FYP and ADY fermentations were done as follows.

Fermentations with S. pastorianus FYP and ADY were done in dry hopped light malt extract and medium malt extract. Dried barley malt extract from Muntons was used for the fermentation media and was mixed with water to a concentration of 10-11° Plato and then autoclaved at 121° C. for 15 minutes.

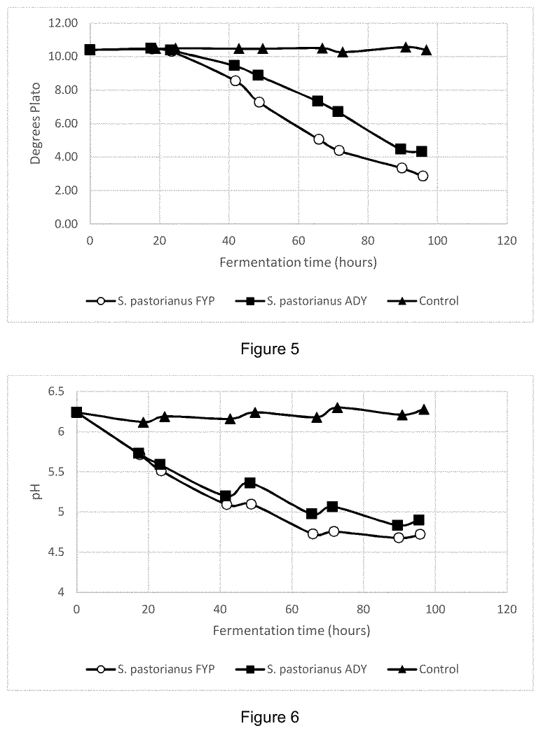

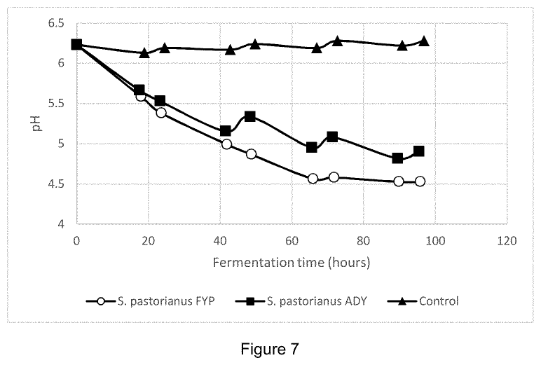

The FYP was inoculated directly after thawing. The ADY samples were inoculated in direct inoculation by directly pouring the ADY into the barley malt medium at ambient temperature (20° C.). All samples were inoculated at a level of 1*10\hat{ }6 CFU/mL. The fermentation was done at 15° C., to get a faster fermentation compared to 12° C., which is still in temperature range for this lager-type S. pastorianus brewing yeast, in 800 mL barley malt medium in glass bottles with a total volume of 1000 mL. The bottles were placed in an incubator at 15° C. The fermentations were followed using plating of the yeast on YGC plates, measuring degrees Plato (° P) with using an Anton Paar Densimeter DMA 35 and measuring pH with a pH meter. Results are shown in FIGS. 4 and 6 for the dry hopped light malt extract and FIGS. 5 and 7 for the medium malt extract. The fermentation set-up is given in the following table 2.

TABLE 2
Fermentation set-up in two different wort media

| Sample | Medium | Volume | Temp (° C.) | CFU/g | Inoculation level | Inoculation type |
|---|---|---|---|---|---|---|
| S. pastorianus FYP | Dry hopped light malt extract | 800 | 15 | 1.5E+09 | 1.0E+06 | Direct |
| S. pastorianus ADY | Dry hopped light malt extract | 800 | 15 | 3.6E+09 | 1.0E+06 | Direct |
| Control | Dry hopped light malt extract | 800 | 15 | | | |
| S. pastorianus FYP | Medium malt extract | 800 | 15 | 1.5E+09 | 1.0E+06 | Direct |
| S. pastorianus ADY | Medium malt extract | 800 | 15 | 3.6E+09 | 1.0E+06 | Direct |
| Control | Medium malt extract | 800 | 15 | | | |

Fermentations with S. pastorianus FYP and ADY were performed in malt extract as described in materials and methods. Two types of media were used for the fermentations: dry hopped light malt extract at 11° P and medium malt extract at 10° P. For each media type, 3 fermentations were carried out in duplicate: 1) S. pastorianus FYP, 2) S. pastorianus ADY and 3) control.

As shown in FIGS. 4 and 5, fermentation with S. pastorianus FYP was faster compared to the S. pastorianus ADY in both media types. The fermentation with S. pastorianus FYP starts faster compared to S. pastorianus ADY and ends 6 h earlier in the dry hopped light malt extract. The fermentation with S. pastorianus FYP is even faster compared to S. pastorianus ADY in the medium malt extract and ends at a lower degree Plato after 4 days. An extra sample was taken after 14 days of fermentation and at that point, the S. pastorianus FYP reached 2 degrees Plato and S. pastorianus ADY reached 2.17 degrees Plato.

The fermentation with S. pastorianus FYP and S. pastorianus ADY was also followed for pH decrease (FIGS. 6 and 7), as this gives an even better idea of the fermentation performance. FIGS. 6 and 7 shows the pH decrease for S. pastorianus FYP and S. pastorianus ADY in dry hopped light extract and medium malt extract. It is clear that S. pastorianus FYP ferments faster in both cases and reaches a lower end pH in both wort media. S. pastorianus FYP was the best performer in both wort media when both degrees Plato and pH were measured. The difference between S. pastorianus FYP and S. pastorianus ADY was even more enhanced when the medium malt extract was used.

1. A closed container containing 0.05 to 50 L of a frozen yeast product, wherein:
the frozen yeast product contains at least one strain effective for beer brewing in a total concentration of at least 10⁹ CFU/g, wherein each yeast strain effective for beer brewing is present in a concentration of at least 10⁸ CFU/g,
upon thawing, the frozen yeast product yields a liquid aqueous suspension with a dry matter content below 35% (w/w); and
the frozen yeast product does not include a cryoprotectant.

2. The closed container containing a frozen yeast product according to claim 1, wherein upon thawing the frozen yeast product yields a liquid aqueous suspension with a dry matter content of 20 to 25% (w/w).

3. The closed container containing a frozen yeast product according to claim 1, wherein the frozen yeast product contains bacterial contaminants in a total amount of less than 10 CFU/g.

4. The closed container containing a frozen yeast product according to claim 1, wherein the frozen yeast product contains a strain selected from one or more of Saccharomyces pastorianus, Saccharomyces cerevisae, and Pichia kluyveri.

5. The closed container containing a frozen yeast product according to claim 1, wherein the yeast strain(s) effective for beer brewing have a vitality of at least 90%.

6. The closed container containing a frozen yeast product according to claim 1, wherein the closed container is a plastic bag.

7. The closed container containing a frozen yeast product according to claim 1, wherein upon thawing the frozen yeast product yields a liquid yeast suspension having a yeast cell concentration of 2×10⁹ to 8×10⁹ and a dry matter content of 20 to 25% (w/w), and consisting of the yeast cells, nutrient medium, water, optionally, degradation products and metabolites thereof, and, optionally, unavoidable contaminants.

8. The closed container containing a frozen yeast product according to claim 1, wherein the frozen yeast product contains at least one strain effective for beer brewing in a total concentration of 2×10⁹ CFU/g to 5×10⁹ CFU/g.

9. A method for producing the frozen yeast product of claim 1, comprising:
growing yeast effective for beer brewing in a nutrient medium to a concentration of at least 10⁸ CFU/g,
concentrating the yeast to a concentration of at least 5×10⁸ CFU/g to obtain a liquid aqueous suspension with a dry matter content below 35% (w/w),
filling the liquid aqueous suspension into a container, and
freezing the liquid aqueous suspension.

10. The method according to claim wherein cellular trehalose content is increased during or subsequent to the growing by inducing a stress response mechanism.

11. The method according to claim 9, wherein the freezing is performed to a temperature of −20 to -60 ° C. over a period of 2 to 5 hours.

12. The method according to claim 9, wherein the nutrient medium contains sugars, vitamins, minerals, and a C16 to C20 fatty acid.

13. A closed container containing a frozen yeast product obtained by the method of claim 9.

14. A method for producing beer, comprising:
providing at least 50 L of wort in a fermentation tank;
connecting the closed container according to claim 1 with the tank,
transferring the yeast product to the fermentation tank; and
fermenting the wort with the yeast product to obtain beer.

15. The method according to claim 14, wherein the wort has a gravity of at least 12° Plato.
